(19) United States
(12) Patent Application Publication
(10) Pub. No.: US 2023/0233006 A1
(43) Pub. Date: Jul. 27, 2023

(54) CONTAINER MAGNETIC DEVICE MOUNT

(71) Applicant: Scosche Industries, Inc., Oxnard, CA (US)

(72) Inventors: Kasidy Alves, Oxnard, CA (US); Vince Alves, Oxnard, CA (US); Yasuhiro Yamamoto, Thousand Oaks, CA (US)

(21) Appl. No.: 17/648,945

(22) Filed: Jan. 26, 2022

(51) Int. Cl. A47G 19/22; F16B 1/00

(52) U.S. Cl. CPC A47G 19/2227; F16B 1/00; A47G 19/2272; F16B 2001/0035

(57) ABSTRACT

A container magnetic mount for a device has a container lid defined by a rim cylindrical wall, a top, and a lid joint element. A device mount head includes a device mount head joint element in rotating engagement with the container lid. The lid joint element and the device mount head joint element define a dynamic coupling, with the device mount head being orientable between a raised reverse position and a lowered forward position. The device mount head incorporates a joint arm and the device mount head joint element, and an angularly offset head body with one or more magnets attractive of a ferromagnetic element on the device.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to mounts for positioning, orienting, and securing smartphones and other electronic devices for optimal usage, and more particularly, to a container magnetic device mount.

### 2. Related Art

A wide variety of portable electronic devices are currently in existence on the market, though there has been a recent convergence towards a fewer category of devices that fulfill many needs. Typically, these are smartphones that which integrate functions and features that may have earlier been provided in separate, independent devices such as music players, gaming consoles, personal digital assistants, digital still and video cameras, electronic readers, mapping and navigation devices, and so on. Several short-to-medium range communications modalities are also integrated, including WiFi and Bluetooth for short-range/local data transfer links, as well as cellular communications systems that can substantially extend its communicative range.

When interacting with the smartphone for a brief moment, it may be held in the hand and placed back down following use. However, there may be some situations in which the user is performing a primary task not with or relating to the smartphone, such as while working out/exercising, but there is still a need or desire for viewing the display and/or interacting with the mobile device. Some exercise routines may call for extended durations of cardiovascular activity with such machines as treadmills, ellipticals, stationary bikes, and rowing machines. In order to avoid boredom, or to make productive use of otherwise idle time, a user may opt to view entertainment or educational programming on the smartphone. Along these lines, a smartphone may be utilized to view live or pre-recorded videos that guide the user along a workout routine. Performance in athletic activities may be improved through visual feedback of one's performance no matter the skill or ability, so instead of just viewing content, the smartphone may be utilized for recording videos of the user performing exercise routines. The captured footage may be immediately reviewed or stored for subsequent review by the user and/or by third parties such as coaches.

As can be appreciated, short of wearing a band with a device holder around the arm, torso, or leg, a loosely held/pocketed smartphone is liable to be thrown about during vigorous activity. Many conventional exercise machines therefore incorporate shelves, ledges, pockets, and like structures throughout its housing, where smartphones may be placed. Most such structures are intended for merely holding the smartphone while the user is engaged in the exercise activity, rather than positioning the display at an optimal viewing angle. Exercise machines oftentimes incorporate bottle holders so that hydration is immediately accessible during the workout. Where there are no dedicated smartphone retention structures, these bottle holders may serve a dual purpose of holding smartphones, media players, and the like. Again, however, the placement and available positioning angles of the smartphone display placed in such bottle holders are typically not ideal for viewing and/or recording.

Various mounting devices have been developed for securing a smartphone to stationary structures beyond the foregoing incidental ones on an exercise machine. One configuration is a cradle that mechanically retains the smartphone, with the cradle being mounted to a structure. The compressive retention mechanisms are oftentimes cumbersome to engage and/or disengage, so more recently, magnetic mounts are being utilized. A mount head including one or more permanent magnets are fixed to the structure, with a metallic plate being attached to the rear of the smartphone. The magnets on the mount engage the metallic plate, thereby releasably engaging the smartphone to the mount.

Whether utilizing a mechanical/compressive retention or a magnetic retention, it is necessary to attach the device mount head to a base structure. This base structure may be that of the exercise machine, which may have tubular structures around which a clamp can be engaged, or a flat surface on which a suction cup or an adhesive may be attached. Furthermore, there are bottle holder mounts that are generally comprised of plugs that are insertable into the bottle holder and include stalk extensions that raise and shift the device mount head to a more idea viewing position. These mounting structures are intended for permanent or semi-permanent installation and may be unsuitable for deployment in public/commercial gyms where many people use a given machine over the course of the day. Removing and attaching the structural mount for each machine by a single user is also cumbersome and may be disruptive to a workout routine.

Beyond the foregoing exercise or workout-related uses of the smartphone to capture video and/or images of the user, there may be other circumstances in which a steady hands-free platform for a smartphone or other recording device is needed. Videoconferencing has become extremely popular for both work and personal purposes. There are several well-know smartphone-installable applications such as Zoom, Facetime, Google Meet, and so forth. Along these lines, short form videos and photographs of one's self engaged in an activity are posted to social media sites. The common thread among all of these scenarios is that there is no static location from which images or footage is captured. For example, good practice may dictate the user participating in work-related videconferences strictly from a dedicated office space, while the same user may conduct personal videoconferences from the kitchen, living room, bedroom, or elsewhere outside. Because video content posted to social media sites are intended to highlight involvement in a range of outside activities, footage may be required from a variety of locations. While tripods may be used for more formal video shoots, setup can be cumbersome, and some locations may ban their use.

Accordingly, there is a need in the art for an improved mounting device for positioning, orienting, and securing smartphone devices. There is a need in the art for magnetic mount heads selectively extendable from personal items such as water bottles that can be placed into existing bottle holders on exercise machines as well as be free-standing. There is a need for a container magnetic device mount.

### BRIEF SUMMARY

The present disclosure contemplates various embodiments of a container magnetic device mount. In one embodiment, there may be a container magnetic mount for a device that includes a container lid defined by a rim cylindrical wall, a shoulder section, and a top defining a passageway. The shoulder section may include one or more lid hinge knuckles. Additionally, the container magnetic mount may include a device mount head that is in rotating engagement with the container lid. The device mount head may include a mount head body and a hinge leaf with one or more mount head hinge knuckles in axial alignment with the one or more lid hinge knuckles. The mount head body may include one or more magnets attractive of a ferromagnetic element on the device and the hinge leaf being angularly offset from the mount head body.

In another embodiment, there may be a liquid container. The liquid container may include a container body that is defined by a container interior and an open rim. There may also be a lid that is engageable to the open rim of the container body. The lid may be defined by a rim cylindrical wall, a spherical segment shoulder, and a top including a platform having a rotatable spout in fluid communication with the container interior. The spherical segment shoulder of the lid may include a lid hinge knuckle. The liquid container may also have a device mount head that is in rotating engagement with the lid. The device mount head may include a mount head body and a hinge leaf with a pair of coaxial mount head hinge knuckles in axial alignment with the one or more lid hinge knuckles. The mount head body may include one or more magnets attractive of a ferromagnetic element on the device. Furthermore, the hinge leaf may be angularly offset from the mount head body. The liquid container may also include one or more hinge bolts that extend through the mount head knuckles and at least partially through the lid hinge knuckle.

In yet another embodiment, there may be a container magnetic mount for a device with a container lid that is defined by a rim cylindrical wall, a top, and a lid joint element. There may also be a device mount head that includes a device mount head joint element in rotating engagement with the container lid. The lid joint element and the device mount head joint element may define a dynamic coupling, with the device mount head being orientable between a raised reverse position and a lowered forward position. The device mount head may further include a joint arm, the device mount head joint element, and an angularly offset head body with one or more magnets attractive of a ferromagnetic element on the device.

The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a first embodiment of a container magnetic mount according to the present disclosure;

FIG. 2A is a side view of the first embodiment of the container magnetic mount showing a device mount head primarily in a reverse raised position;

FIG. 2B is a rear perspective view of the first embodiment of the container magnetic mount with the device mount head in the reverse raised position;

FIG. 3 is a perspective view of the first embodiment of the container magnetic mount with the device mount head in the forward lowered position;

FIG. 4 is an exploded perspective view of the first embodiment of the container magnetic mount with the device mount head separated from the lid;

FIG. 5 is an exploded perspective view of a second embodiment of the container magnetic mount with the device mount head separated from the lid;

FIG. 6 is a perspective view of a third embodiment of the container magnetic mount; and

FIG. 7 is a perspective view of a fourth embodiment of the container magnetic mount.

### DETAILED DESCRIPTION

The detailed description set forth below in connection with the appended drawings is intended as a description of the several presently contemplated embodiments of a container magnetic device mount and is not intended to represent the only form in which such embodiments may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second, proximal and distal, left and right, front and rear, and the like are used solely to distinguish one from another entity without necessarily requiring or implying any actual such relationship or order between such entities.

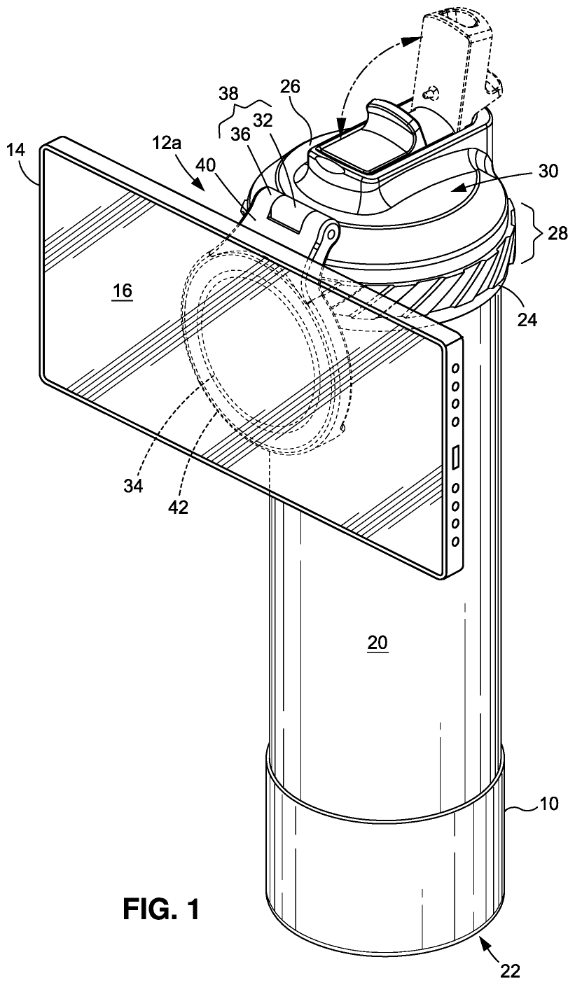

FIG. 1 depicts a liquid container 10 that incorporates a first embodiment of a container magnetic mount 12a. A device 14 is shown temporarily attached to the container magnetic mount 12. The device 14 is understood to be a smartphone, a media player, or other like personal electronic device that has a front-facing display 16. The device 14 is understood to include a data processor that executes various instructions that result in outputs being generated on the display 16. Moreover, the device 14 may include wireless communications subsystems to retrieve audio and video media data that is then presented/played back on the display 16.

Various embodiments of the present disclosure contemplate the device 14, and specifically the display 16 thereof, to be positionable/orientable for optimal viewing of such media content by a user. The components of the device 14 are incorporated within a housing or case that is further defined by a rear face 18 opposite the front-facing display 16. In some cases, the rear face 18 may incorporate ferro-magnetic materials to engage a corresponding magnet on an inductive charging head. Alternatively, an aftermarket metallic/ferromagnetic plate may be adhesively attached to the rear face 18.

The liquid container 10 may have a generally cylindrical configuration with a hollow interior to hold beverages such as water, juice, or sports drinks. In this regard, the liquid container 10 has a cylindrical sidewall 20 and a closed circular bottom 22. A top end 24 of the liquid container 10 is open with the cylindrical sidewall 20 defining a rim, with a lid 26 being engageable thereto. In typical implementations, an outer portion of the cylindrical sidewall 20 is threaded, with a corresponding thread defined on the interior of the lid 26 such that the lid 26 is secured to and closes off the open top end 24. The details of the thread, including the pitch and other dimensional parameters thereof are not shown, though it is deemed to be within the purview of those having ordinary skill on the art to incorporate such securing modalities into the container 10/lid 26.

According to one embodiment, the lid 26 may be generally defined by a rim cylindrical wall 28 and a circular top portion 30. Additionally, the lid 26 includes a lid joint element 32, with further structural details thereof being described more fully below. The container magnetic mount 12 has a device mount head 34 and includes a device mount head joint element 36 that is in rotating engagement with the lid joint element 32. The device mount head joint element 36 and the lid joint element 32 together define a dynamic coupling 38, such that the device mount head 34, and hence the device 14 mounted thereto, can be rotated to a desired orientation.

The device mount head 34 can have a variety of configurations, though in the first embodiment of the container magnetic mount 12 shown, there may be a joint arm 40 that includes the aforementioned device mount head joint element 36. The joint arm 40 is structurally contiguous with a head body 42, which incorporates one or more magnets that are attractive of the ferromagnetic element embedded in or attached to the rear face 18 of the device 14. The head body 42 is understood to be angularly offset relative to the joint arm 40, such that when the device mount head 34 is in the lowered position as depicted in FIG. 1, the head body 42 is substantially parallel to the rim cylindrical wall 28 and/or the cylindrical sidewall 20 of the liquid container 10.

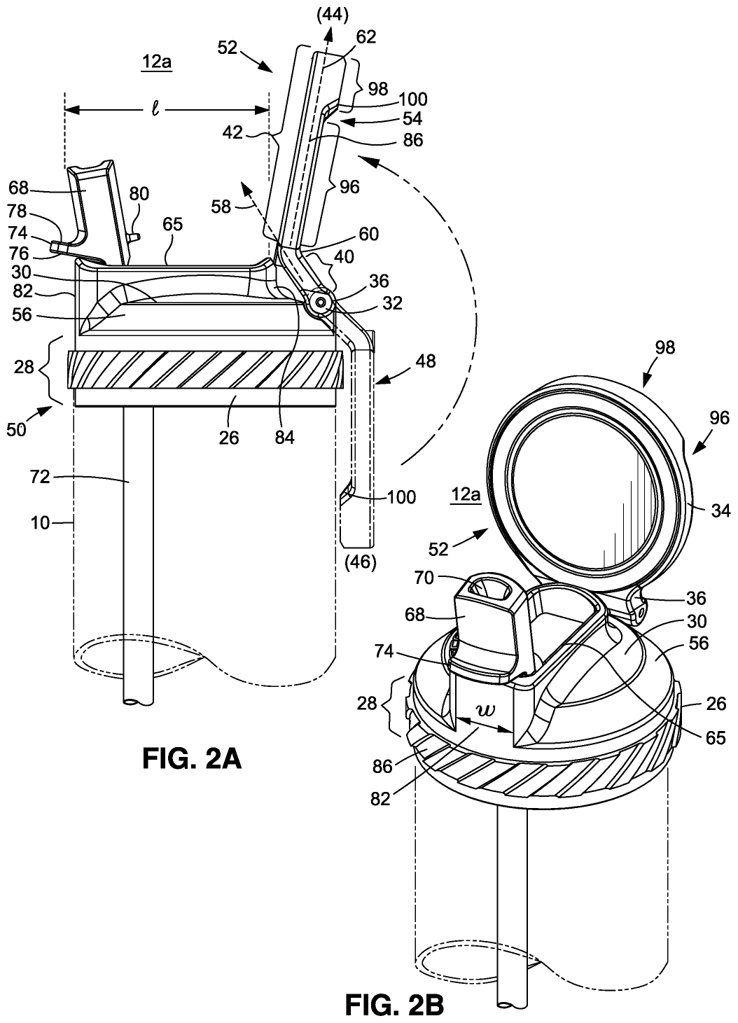

With reference to FIG. 2A and FIG. 2B, the device mount head 34 may be rotated between a raised reverse position 44 and a lowered forward position 46, as well as any angle in between. Only for purposes of referential consistency, the liquid container 10 and the lid 26 are understood to have forward side 48 and an opposed rearward side 50. Independent of the liquid container 10 and the lid 26t, the device mount head 34 may be defined by a front face 52 and a rear face 54. When the device mount head 34 is rotated to the raised reverse position 44, the front face 52 is oriented toward the rearward side 50. When the device mount head 34 is rotated to the lowered forward position, the front face 52 is oriented toward the forward side 48.

As indicated above, the lid 26 is defined by the rim cylindrical wall 28 and the circular top portion 30. In the illustrated embodiment, between the circular top portion 30 and the rim cylindrical wall 28 is a transition or shoulder portion 56. This shoulder portion 56 may have a spherical segment shape, that is, characterized by a curved or arcuate cross-section that generally corresponds to that of a segment of a sphere. The specific configuration of the shoulder portion 56 is presented by way of example only and not of limitation, and any other shape or geometric profile may be substituted. The lid joint element 32 extends from such shoulder portion 56 and is structurally contiguous with the lid 26, while the device mount head joint element 36 is structurally contiguous with the joint arm 40. In further detail, the joint arm 40 defines a lid arm extension axis 58 and is joined with the head body 42 at an elbow 60. The head body 42, in turn, defines a head body extension axis 62, which has a proscribed angular offset relative to the lid arm extension axis 58.

According to one embodiment, the lid 26 also incorporates a spout platform 64 on the circular top portion 30. The spout platform 64 partly bisects the circular top portion 30 and is defined by a length l and a width w. There is a spout receptacle 66 defined within the spout platform 64 that accepts a rotatable spout 68. Defined within the spout 68 is a passageway 70 that is in fluid communication with a straw or conduit 72 extending into the interior of the liquid container 10.

The spout 68 additionally incorporates a finger tab 74 that aids in the rotation of the spout between an open position and a closed position. In the closed position, it is understood that the conduit 72 is pinched off to restrict fluid flow between the passageway 70 and the conduit 72 and faces the forward side 48 of the lid 26. On the other hand, in the open position, the spout 68 extends generally upwardly, and slightly angled toward the rearward side 50 of the lid 26. The finger tab 74 may be defined by a front end 76 and an opposed rear end 78, with the rotational extent of the finger tab 74 being limited by the obstruction of an upper rim 65 of the spout platform 64 against the front end 76 of the finger tab 74. The side of the spout 68 opposite the finger tab 74 may include an airway plug 80 that blocks an opening on the lid 26 to the interior of the liquid container 10. This opening is understood to aid in equalizing the pressure in the liquid container 10 as liquid flows out therefrom through the passageway 70. With the spout 68 rotated to the closed position and the airway plug 80 blocking the opening, a further restriction of liquid outflow additional to the pinched off passageway 70 may be provided.

The spout platform 64 has a vertical wall 82 on the rearward side 50 of the lid 26 that is generally coextensive with the rim cylindrical wall 28. The opposing vertical wall 84 on the forward side 48 of the lid 26 may similarly limit the rotation of the device mount head 34 to a position generally coinciding with the raised reverse position 44 mentioned above. The forward side 48 of the elbow may encounter the upper rim 65 of the vertical wall 84. On the other hand, the obstruction of the shoulder portion 56 encountered by the device mount head 34, and specifically the rear face 54 of the joint arm 40, defines the rotational limit of the device mount head 34 to a position generally coinciding with the lowered forward position 46. The illustrated specifics of the lid 26 as pertaining to its liquid delivery, stopper, and other functionalities not pertaining to the device mount head 34 is presented by way of example only and not of limitation. It will be recognized by those having ordinary skill in the art that there are wide range of designs for lids 26 utilized in connection with water bottles/container 10, and the features of the device mount head 34 and the dynamic coupling to the lid 26 may be adapted to such alternative designs.

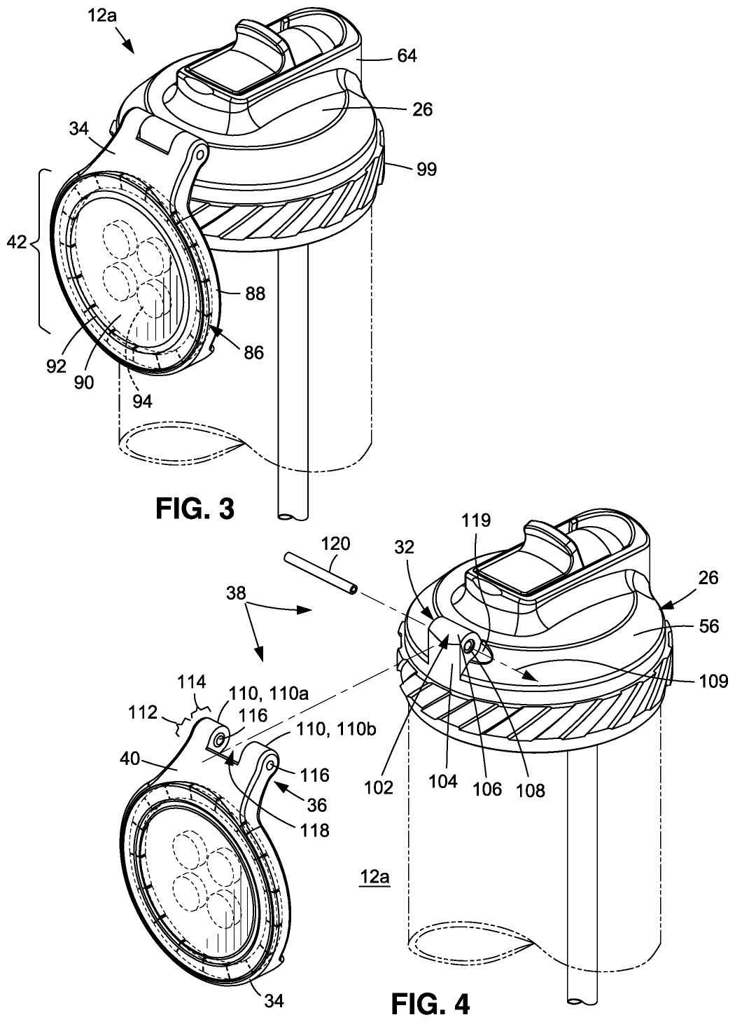

FIG. 3 illustrates the generally circular shape of the head body 42, which is sized to have a diameter that is greater than the width w of the spout platform 64 while being less than the diameter of the lid 26. The head body 42 may be further defined by an outer frame 86 with a circular sidewall 88, along with a thinner puck structure 90 centrally located within the bounds of the outer frame 86. Spaced around the circumference of the outer frame 86 may be a series of permanent magnet elements 92 that are attractive of the ferromagnetic element of the device 14. The permanent magnet elements 92 may be of any suitable magnetic material, including composites, rare earth elements, and so forth. In addition to the permanent magnet elements 92 positioned around the circumference of the outer frame 86, the puck structure 90 may also include a set of permanent magnet elements 94. These may be disc-shaped and embedded into the puck structure 90, specifically near and clustered around a center region thereof. The quantity and relative size of the permanent magnet elements 94 are presented by way of example only, and the embodiments of the present disclosure need not be limited to such configuration. While the head body 42 has been described in terms of the discrete components of the outer frame 86 and the puck structure 90, this is by way of example only. These two components may be integrally constructed, that is, define a single unitary structure, but may be comprised of different sections, segments or parts corresponding thereto.

Referring back to FIG. 2A and FIG. 2B, the circular sidewall 88 may have a thin section 96 and a thick section 98. Although the puck structure 90 defines a thickness that may be coextensive with the thickness of the thin section 96, it is not understood to have a differing thickness at the thick section 98. Thus, the thick section 98 may define a lip 100 that aids in the manual carrying of the device mount head 34 with it being in the raised reverse position 44, as well as in the manual rotation of the same from the lowered forward position 46 to the raised reverse position 44, or somewhere in between. Reference herein to the thin section 96 and the thick section 98 is understood to be only in relation to each other, in that the thin section 96 has a reduced thickness relative to the thick section 98. The specific difference in thicknesses is immaterial, however.

As shown in the various embodiments, there may be an annular grip 99 that encircles the rim cylindrical wall 28. The grip 99 may be constructed of an elastic, elastomeric, or another type of material that has a higher coefficient of friction than the metal of the rim cylindrical wall 28 to provide improved grip when removing/installing the lid 26 on to the liquid container 10. The grip 99 may be a separate component from the lid 26, co-molded into the lid 26, or be constructed of the same material as the lid 26, with the additional friction being provided by an external pattern imprinted or molded on the grip 99 that increases its surface area.

FIG. 4 illustrates one variation of the dynamic coupling 38 that is generally defined by the lid joint element 32 and the device mount head joint element 36. In further detail, the lid joint element 32 can be a single lid hinge knuckle 102 that extend from the shoulder portion 56, or any other suitable part of the lid 26. The lid hinge knuckle 102 is defined by the vertical wall 104 that is generally coplanar with the rim cylindrical wall 28 of the lid 26, as well as a radiused portion 106. Defined in the lid hinge knuckle 102, and located centrally relative thereto is a transverse lid hinge barrel 108 having a barrel axis 109.

The device mount head joint element 36, on the other hand, may be a pair of axially aligned mount head hinge knuckles 110 that extend from joint arm 40. In the illustrated embodiment, there may be a left mount head hinge knuckle 110a and a right mount head hinge knuckle 110b. The mount head hinge knuckles 110 are each defined by a straight wall 112 and a radiused portion 114. The straight wall 112 is understood to be coplanar or tangent with the joint arm 40. In this regard, the joint arm 40 may also be referred to as a hinge leaf 113. Generally centered in each of the mount head hinge knuckles 110 are mount head hinge barrels 116 that are coaxial to each other. Although a configuration of a single lid hinge knuckle 102 and a pair of mount head hinge knuckles 110 is presented, there may be more than one lid hinge knuckle, or only a single mount head hinge knuckle.

An open slot 118 that separates the left and right mount head hinge knuckle 110a, 110b is sized and configured to receive the lid hinge knuckle 102. Furthermore, the shoulder portion 56 defines a chord notch 119 on each side of the lid hinge knuckle 102. The chord notch 119 may have a generally cylindrical configuration that matches that of the radiused portions 114 of the mount head hinge knuckles 110. The chord notch 119 thus acts as a bearing surface upon which the mount head hinge knuckles 110 rotate.

When coupled, the mount head hinge barrels 116 and the lid hinge barrel 108 are understood to be axially aligned, such that a hinge pin 120 may be inserted through each. The diameter of the lid hinge barrel 108 is understood to be slightly greater than the diameter of the hinge pin 120, such that free rotational movement is possible. However, in some embodiments, the diameter of the lid hinge barrel 108 may be sized for a slight friction fit with the hinge pin 120. Along these lines, the mount head hinge barrels 116 are likewise sized for a frictional retention fit with the hinge pin 120.

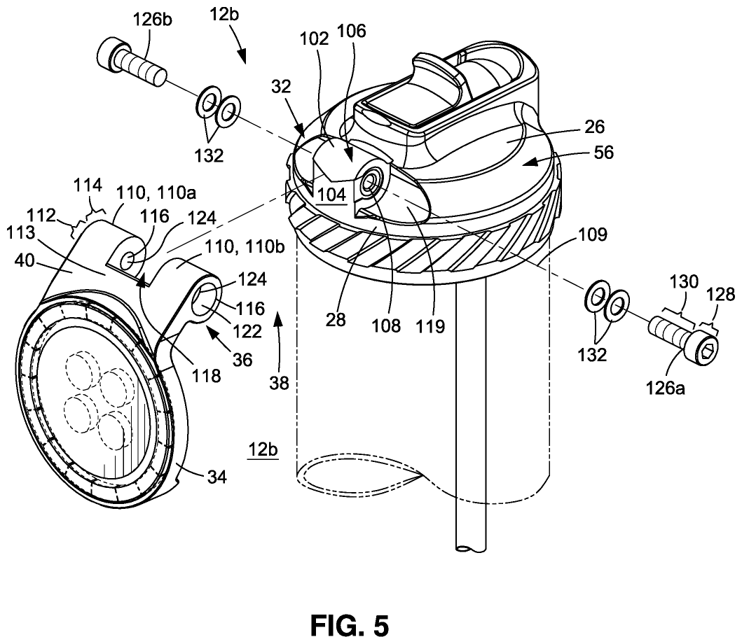

FIG. 5 illustrates a second embodiment of the container magnetic mount 12b with a differently configured dynamic coupling 38. The shoulder portion 56 of the lid 26 defines a more pronounced or deeper/wider chord notch 119, and extending centrally therefrom is the lid hinge knuckle 102. Similar to the first embodiment, the lid hinge knuckle 102 is defined by the vertical wall 104 that is generally coplanar with the rim cylindrical wall 28 of the lid 26. The lid hinge knuckle 102 also has the radiused portion 106. Defined in the lid hinge knuckle 102, and located centrally relative thereto is the transverse lid hinge barrel 108 having a barrel axis 109. For reasons detailed more fully below, the lid hinge barrel 108 may be threaded, with the threading extending across the width of the lid hinge knuckle 102.

The device mount head joint element 36 includes a pair of axially aligned mount head hinge knuckles 110 that extend from the joint arm 40/hinge leaf 113. Thus, there is a left mount head hinge knuckle 110a and a right mount head hinge knuckle 110b. The mount head hinge knuckles 110 are each defined by the straight wall 112 and a radiused portion 114. The straight wall 112 is understood to be tangent to the hinge leaf 113. In this regard, the joint arm 40 may also be referred to as a hinge leaf 113. Again, although a configuration of a single lid hinge knuckle 102 and a pair of mount head hinge knuckles 110 is presented, there may be more than one lid hinge knuckle, or only a single mount head hinge knuckle.

Generally centered in each of the mount head hinge knuckles 110 are mount head hinge barrels 116 that are coaxial to each other. Unlike the first embodiment of the container magnetic mount 12 described above, however, the mount head hinge barrels 116 are defined by outer knuckle barrel 122 and an inner knuckle barrel 124 that is located towards the open slot 118. The outer knuckle barrel 122 has a larger diameter than the inner knuckle barrel 124.

The open slot 118 that separates the left and right mount head hinge knuckle 110a, 110b is sized and configured to receive the lid hinge knuckle 102. Again, the chord notch 119 can have a generally cylindrical configuration that matches that of the radiused portions 114 of the mount head hinge knuckles 110, with the chord notch 119 acting as the bearing surface upon which the mount head hinge knuckles 110 rotate.

When coupled, the mount head hinge barrels 116 and the lid hinge barrel 108 are understood to be axially aligned. Inserted from the outer left and right sides of the respective mount head hinge knuckles 110a, 110b, are corresponding threaded bolts 126a, 126b. The threaded bolts 126 are understood to be defined by a bolt head 128 and a threaded bolt shaft 130, with the bolt shaft 130 having a lesser diameter than the bolt head 128. The bolt head 128 is configured to be received within the outer knuckle barrel 122 but not the inner knuckle barrel 124, while the bolt shaft 130 is configured to be received through the outer knuckle barrel 122 and the inner knuckle barrel 124, and then into the threaded lid hinge barrel 108. A pair of washers 132 may buffer the bolt head 128 against the interior bottom of the outer knuckle barrel 122. The bolts 126 are thus understood to rotatably couple the mount head hinge knuckles 110 to the lid hinge knuckle 102. With the bolts 126 torqued down into the lid hinge barrel 108, a compressive force is imparted from the mount head hinge knuckles 110 to the opposed sides of the lid hinge knuckle 102. This compressive force is understood to impart a tendency to retain the device mount head 34 to the lid 26 in a static orientation. With the application of a suitable amount of force, the device mount head 34 may be rotated/re-oriented to a desired angle. Those having ordinary skill in the art will recognize the range of torque specifications for the bolts 126 that make such a functionality possible. Along these lines, it will also be appreciated that other conventional braking mechanisms such as counter-angled splines incorporated into the abutting faces of the knuckles may also be utilized.

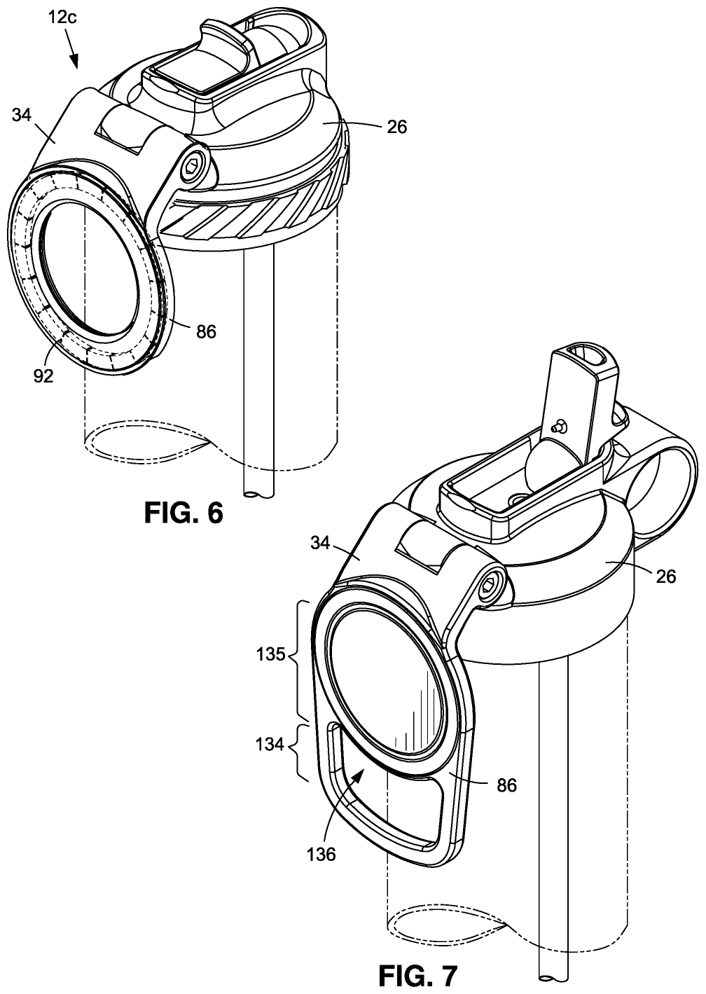

In the first and second embodiments of the container magnetic mount 12a, 12b described above, the device mount head 34 was comprised of the outer frame 86 and the central puck structure 90. A first set of the permanent magnet elements 92 were disposed around the circumference of the outer frame 86, while another second set of permanent magnet elements 94 were clustered in the center of the puck structure 90. A third embodiment of the container magnetic mount 12c shown in FIG. 6 may eliminate the puck structure 90, leaving only the annular structure of the outer frame 86. The first set of permanent magnet elements 92 continue to be positioned around the circumference of the outer frame 86 and are understood to be attractive of the ferromagnetic elements on the device 14. In this configuration, the device mount head 34 may be usable as a carry handle, or as the structure to grasp for rotating the device mount head from the raised reverse position 44 and the lowered forward position 46, as well as any orientation in between. In all other respects, however, the third embodiment of the container magnetic mount 12c is understood to be the same as the second embodiment 12b.

A fourth embodiment of the container magnetic mount 12c shown in FIG. 7 is likewise comprised of the lid 26 that is rotatably engaged to a variation of the device mount head 34. The dynamic coupling 38 is understood to be the same as in the second and third embodiments 12b, 12c described above, but the outer frame 86 includes an additional handle extension 134 from the annular portion. The handle extension 134 defines an opening 136 that may be grasped for carrying the container magnetic mount 12, or to rotate the same between the raised reverse position 44 and the lowered forward position 46. This fourth embodiment 12d retains the central puck structure 90 with the secondary magnetic elements (not shown) embedded and clustered in a central region thereof. Moreover, the first set of magnetic elements (not shown) are understood to be disposed around the circumference of the outer frame 86. The specific size and shape of the handle extension 134 is presented by way of example only and not of limitation, and any other structure that aids in the carry and/or support of the device 14 may be utilized without departing from the present disclosure.

Utilizing the container magnetic mount 12 in accordance with various embodiments of the present disclosure, the device mount head 34 and the device 14 attached thereto may be oriented with the display 16 generally toward the forward side 48 of the liquid container 10, as shown in FIG. 1. This may be appropriate while storing or transporting the combination of the device 14 and the liquid container 10. There may also be a slightly greater angular range between the lowered forward position 46 and laying flat, as opposed to the stopping angle just short of 90 degrees with the raised reverse position 44. Accordingly, for some applications in which a vertical orientation is needed (e.g., the container 10 is positioned at a higher location, or the container magnetic mount 12 substitutes for a monopod/tripod) the lowered forward position 46 may be the more appropriate. The device mount head 34 and the device 14 may also be oriented with the display 16 generally toward the reverse side 50 of the liquid container 10. This orientation may be suitable when immediate access to the spout 68 is desired while viewing or recording content, such as while participating in videoconferences during exercise activities. It will be appreciate that these uses cases are exemplary only, and there may be other scenarios in which one orientation or another is more suitable. Those having ordinary skill in the art will recognize and appreciate such alternatives.

The particulars shown herein are by way of example and for purposes of illustrative discussion of the embodiments of a container magnetic device mount and are presented in the cause of providing what is believed to be the most useful and readily understood description of the principles and conceptual aspects. In this regard, no attempt is made to show details with more particularity than is necessary, the description taken with the drawings making apparent to those skilled in the art how the several forms of the present disclosure may be embodied in practice.

What is claimed is:

1. A container magnetic mount for a device, comprising:
a container lid defined by a rim cylindrical wall, a shoulder section, and a top defining a passageway, the shoulder section including one or more lid hinge knuckles; and
a device mount head in rotating engagement with the container lid, the device mount head including a mount head body and a hinge leaf with one or more mount head hinge knuckles in axial alignment with the one or more lid hinge knuckles, the mount head body including one or more magnets attractive of a ferromagnetic element on the device and the hinge leaf being angularly offset from the mount head body.

2. The container magnetic mount of claim 1, wherein the shoulder section has a spherical segment shape, and further defines a chord notch with a cylindrical profile.

3. The container magnetic mount of claim 2, wherein the one or more mount head hinge knuckles have an outer radiused section corresponding to the cylindrical profile of the chord notch and a flat section tangent with the hinge leaf.

4. The container magnetic mount of claim 2, wherein the one or more lid hinge knuckles extend from the chord notch.

5. The container magnetic mount of claim 4, wherein the one or more lid hinge knuckles defines an outer radiused section and a flat section tangent with the rim cylindrical wall.

6. The container magnetic mount of claim 1, further comprising one or more hinge pins extending through the one or more mount head knuckles and at least partially through the one or more lid hinge knuckles.

7. The container magnetic mount of claim 6, wherein the one or more lid hinge knuckles and the one or more mount head hinge knuckles each define a corresponding barrel.

8. The container magnetic mount of claim 7, wherein the barrel of each of the one or more mount head hinge knuckles is characterized by an outer barrel portion and an inner barrel portion.

9. The container magnetic mount of claim 8, wherein each of the one or more hinge pins includes a pin head and a pin shaft, the pin head being sized and shaped to be received into a respective one of the outer barrel portions of the mount head hinge knuckle, and the pin shaft being sized and shaped to be received into a respective one of the inner barrel portions of the mount head hinge knuckle.

10. The container magnetic mount of claim 9, wherein the barrel of the one or more lid hinge knuckles is threaded.

11. The container magnetic mount of claim 1, wherein the mount head body is defined by an annular frame, the one or more magnets being positioned along the circumference of the annular frame.

12. The container magnetic mount of claim 1, wherein the mount head body has a flat circular structure, at least one of the one or more magnets being positioned on the flat circular structure.

13. The container magnetic mount of claim 12, wherein the mount head body further includes a handle extending from the flat circular structure, the handle and the flat circular structure defining a handle opening.

14. A liquid container, comprising:
a container body defined by a container interior and an open rim;
a lid engageable to the open rim of the container body, the lid being defined by a rim cylindrical wall, a spherical segment shoulder, and a top including a platform having a rotatable spout in fluid communication with the container interior, the spherical segment shoulder including a lid hinge knuckle;
a device mount head in rotating engagement with the lid, the device mount head including a mount head body and a hinge leaf with a pair of coaxial mount head hinge knuckles in axial alignment with the one or more lid hinge knuckles, the mount head body including one or more magnets attractive of a ferromagnetic element on the device and the hinge leaf being angularly offset from the mount head body; and
one or more hinge bolts extending through the mount head knuckles and at least partially through the lid hinge knuckle.

15. The liquid container of claim 14, wherein the mount head body is defined by an annular frame, the one or more magnets being positioned along the circumference of the annular frame.

16. The liquid container of claim 14, wherein the mount head body has a flat circular structure, at least one of the one or more magnets being positioned on the flat circular structure.

17. The liquid container of claim 16, wherein the mount head body further includes a handle extending from the flat circular structure, the handle and the flat circular structure defining a handle opening.

18. A container magnetic mount for a device, comprising:
a container lid defined by a rim cylindrical wall, a top, and a lid joint element; and
a device mount head including a device mount head joint element in rotating engagement with the container lid, the lid joint element and the device mount head joint element defining a dynamic coupling with the device mount head being orientable between a raised reverse position and a lowered forward position, the device mount head including a joint arm including the device mount head joint element and an angularly offset head body with one or more magnets attractive of a ferromagnetic element on the device.

19. The container magnetic mount of claim 18, wherein the lid joint element and the device mount head joint element are hinge knuckles, and further including at least one hinge pin inserted through barrels of the hinge knuckles.

20. The container magnet mount of claim 18, wherein the top of the container lid includes a rotatable spout.
